(19) United States
(12) Patent Application Publication
(10) Pub. No.: US 2022/0185161 A1
(43) Pub. Date: Jun. 16, 2022

(54) MAGNETIC HAIL DAMAGE PREVENTER FOR CARS

(71) Applicant: Robert Dewitt McDowell, Arcadia, LA (US)

(72) Inventor: Robert Dewitt McDowell, Arcadia, LA (US)

(21) Appl. No.: 17/120,143

(22) Filed: Dec. 12, 2020

(51) Int. Cl. B60N 3/04

(52) U.S. Cl. CPC B60N 3/046; B60N 3/048

(57) ABSTRACT

The invention is an apparatus for preventing automotive hail damage by the use of magnetic floor mats. These mats may be placed in specific areas and are held in place by a magnetic layer.

### BACKGROUND OF THE INVENTION

The present invention relates to the prevention of damage to automobile bodies during hailstorms. Hail damage is and has been a major problem for automobile owners, especially in areas where hailstorms are frequent. It can be as expensive to repair hail damage to a car as most minor accidents. In a damaged vehicle that is not a total loss, the damage is usually limited to a specific area of the car body, while hail damage always covers the entire car. Each year an enormous amount of money is spent repairing such damage. The present invention is an effective way of preventing this loss.

### DESCRIPTION OF THE PRIOR ART

At present, there are no effective and convenient ways to prevent hail damage to cars. Your only defense is to make a mad dash for the nearest unoccupied canopy or shed or to have your car stored at all times.

### BRIEF DESCRIPTION OF THE DRAWINGS

FIG. 1 is a top elevation view of a set of standard floor mats.

FIG. 2 is an explosion view of one of each floor mats.

FIG. 3 is an explosion view of a rolled trunk mat.

### DETAILED DESCRIPTION

The present invention consists essentially of hail protective material formed into floor mats. These floor mats are magnetic and therefore cling to the area of the car body that they are laid upon during hailstorms. When the driver fears approaching hail, or gets a weather alert, he or she simply removes the floor mats and uses them to cover the vulnerable parts of the car body. These magnetic floor mats will be designed specifically for the car model in which they are used. They may be molded to fit the floorboard, plain flat mats, or rolled for storage.

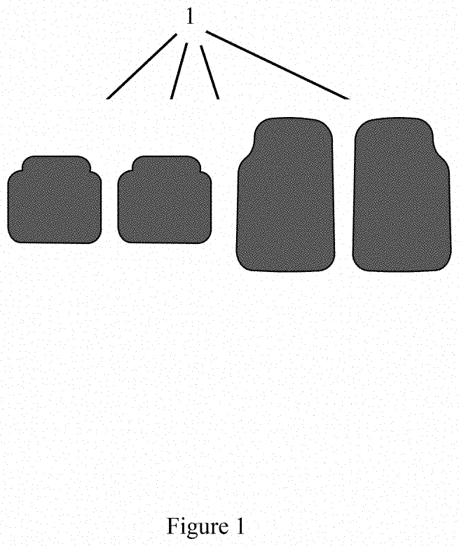

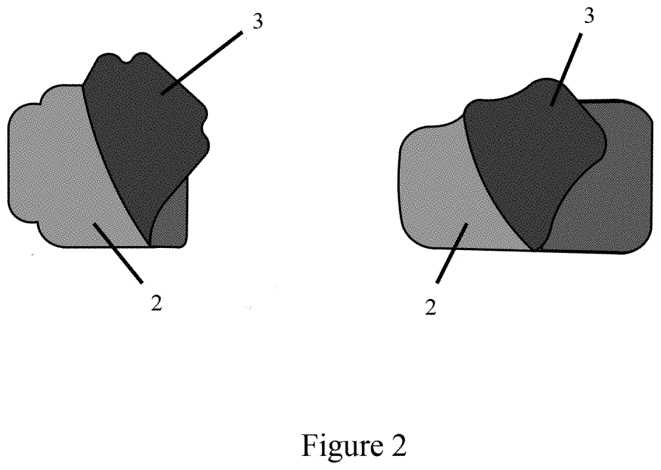

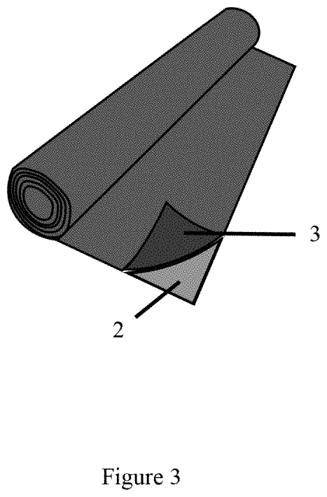

Referring to the drawings and more specifically to FIGS. 1 and 2, it can be seen that a set of floor mats 1 consists of a lower magnetic layer 2 and an upper layer 3. Upper layer 3 is made of hail resistant material. Referring to FIG. 3 it can be seen that a trunk mat 4 is rolled up for storage. The trunk mat also has a lower magnetic layer 2 and an upper hail resistant layer 3. When a hailstorm seems imminent, the car owner can place the magnetic floor mats atop his vehicle and thereby protect his car's finish. The magnetic layer keeps the covering from being blown away by the wind that usually accompanies a hail storm.

1. An apparatus for preventing hail damage to automobile panels and other surfaces, said apparatus comprising; an automotive floor mat, said floor mat further comprising an upper layer and a lower layer, said upper layer being comprised of material capable of preventing hail damage, said lower layer being comprised of magnetic material, said upper layer and said lower layer being formed together so as to created said floor mat, said floor mat being capable of magnetically adhering to said automotive panels and other surfaces, thus preventing hail damage.
